(19) United States
(12) Patent Application Publication
(10) Pub. No.: US 2012/0020828 A1
(43) Pub. Date: Jan. 26, 2012

(54) METHOD OF PREVENTING OXIDATION OF METALS IN THERMAL SPRAYING

(75) Inventors: Tomi Suhonen, Espoo (FI); Tommi Varis, Espoo (FI); Erja Turunen, Espoo (FI); Tapio Ritvonen, Tampere (FI)

(73) Assignee: TEKNOLOGIAN TUTKIMUSKESKUS VTT, Espoo (FI)

(21) Appl. No.: 13/254,471

(22) PCT Filed: Mar. 3, 2010
(86) PCT No.: PCT/FI10/50164

§ 371 Date: Oct. 7, 2011

(30) Foreign Application Priority Data
Mar. 3, 2009 (FI) 20095212

(51) Int. Cl. B05D 1/02; C22C 27/04

(52) U.S. Cl. 420/431; 427/422

(57) ABSTRACT

The invention relates to a method for preventing the oxidation of metals in thermal spraying by coating the metallic powders to be used with nanocarbides, to a coating achieved using the method as well as to a method for treating the metal powder with nanocarbides. The methods according to the invention are suitable for all metal powders used in thermal spraying and, as the invention enables the use of cheaper materials, they are economically extremely advantageous.

The invention relates to the method of the claim for preventing the oxidation of metals in thermal spraying and a method of coating metal powders.

Previously, efforts have been made to minimize oxidation by alloying the material to be sprayed, whereby the oxygen affinity of the mixture has decreased. However, using expensive alloying agents does not completely prevent the generation of oxide layers on the coating.

Another solution has been the vacuum plasma spraying (VPS), whereby a completely oxygen-free coating is achieved, but the method is not used unless absolutely necessary due to its extremely high manufacturing costs. For example, those who coat gas turbines actively tend to avoid VPS coating due to the high manufacturing costs.

The US publication No. 6,376,103 describes the manufacture of metal powders, which can be used for coatings produced by thermal spraying. The metal powders of the publication are produced into agglomerates of metal carbide composites, whereby the carbide is included in the powder particle itself.

Thus, optimizing the amount of carbide for different metals and alloys is the greatest challenge of the present invention. It should be sufficient for the thermally sprayed coating not to oxidize, but not too high, leaving too much unreacted carbides in the coating. The releasing speed of carbon in the spraying depends on which carbide is used. When carbon is released from carbide, the metal component of the carbide remains in the coating, whereby the carbide also should be selected according to its applicability.

Generally, one of the greatest problems of thermally sprayed metal coatings is their brittleness and, typically, their weak corrosion protection. Invariably, in all of the applications of thermally sprayed metal coatings, such as electrically/heat conductive layers, corrosion preventing coatings or thermal barrier coatings (TBC) of gas turbines, the tendency is to achieve a coating that is oxidized as little as possible. To minimize the oxidation during spraying, extremely complex and expensive metal alloys must be used in the applications.

The method according to the invention has the potential to eliminate the problems occurring in the previously known solutions. As the invention enables the use of cheaper materials, the method according to the invention is economically extremely advantageous.

The method for preventing the oxidation of metals in thermal spraying according to the invention is characterized by that, which is stated in the characterizing part of claim 1.

The thermally sprayed coating according to the invention, in turn, is characterized by that, which is stated in claim 4, and the method for coating the metal powder according to the invention is characterized by that, which is stated in claim 8.

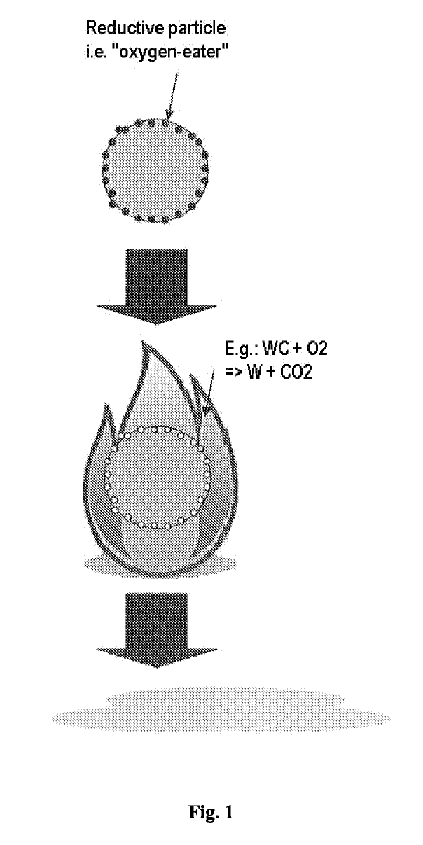

An embodiment of the invention is illustrated in detail referring to FIG. 1, which presents the reaction that takes place according to this embodiment.

The present invention relates to a method for preventing the oxidation of metals in thermal spraying, wherein nanocarbides are attached to the surface of metal powders, after which the coated metal powder is sprayed by thermal spraying to form a metal coating on the surface of a body (i.e., a base sprayable by thermal spraying), whereby the nanocarbides provide a reduction reaction of the carbides on the surface of the metal powder particles during the molten state of the spraying, so that the surface of the molten metal drop is not allowed to oxidize.

The invention also relates to a thermally sprayed coating achieved using this method as well as to a method for coating said metal powders that are used in the thermal spraying.

Thermally sprayed coatings are formed when the molten drops solidify on the surface of the body. In a conventional method, the molten metal drops are allowed to react with ambient oxygen during the spraying, thus forming oxide layers in the coating. The nanocarbides (such as tungsten carbide or WC), which are attached to the surfaces of the metal powders used for the coating in the thermal spraying, protect the oxidation of metal during spraying. The carbides release carbon in a controlled manner, the carbon reacting with the ambient oxygen, forming gaseous compounds (CO, CO₂), whereby the surface of the molten metal drop cannot be oxidized. In this way, no oxide layers are formed in the coating. Pure carbon would react too quickly with the ambient oxygen, whereby the protective property would not be achieved.

The greatest problems of thermally sprayed metal coatings relate to brittleness and poor corrosion protection, which are provided by the oxide layers.

In FIG. 1, the aim of the material called “oxygen-eating” carbide is to provide a reduction reaction on the surface of the metal particle to compensate for the oxidation that occurs during the molten state. This has been observed when examining carbide metal matrix composite coatings, wherein the intention is to avoid the loss of carbon in coating, since the carbides are destroyed. For example, WC degrades into carbon and metallic tungsten in the coating process. According to the invention, the same phenomenon can be utilized to provide a controlled reduction, wherein the carbon being released reacts with oxygen, forming carbon dioxide while simultaneously protecting the metal against oxidation.

Knowledge in producing nanocarbides by means of a water-based synthesis (a cost-effective way of manufacturing nanocarbides) is used in the invention. The process can be modified so that the nanocarbides are formed from an aqueous slurry directly onto the surfaces of the metal particles. This hardly increases the powder manufacturing costs. In addition, cheaper metals can be used in the applications, whereby the total costs are considerably reduced. Oxygen-free coatings would also open up an extensive spectrum of new applications, wherein the performance of present metal coatings has no longer been sufficient.

The invention is suitable for all metal powders of thermal spraying, and it may revolutionize the manufacture of thermally sprayed metal powders as well as enable the exploitation of metal coatings in more and more applications.

1.-10. (canceled)

11. A method for preventing the oxidation of metals in thermal spraying, comprising
attaching nanocarbides to the surface of metallic powder particles to be used in thermal spraying, followed by
spraying the coated metallic powder by thermal spraying into a metal coating on the surface of a body, whereby the nanocarbides provide a reduction reaction of the carbides on the surface of the metal powder particles during the molten state of the spraying, so that the surface of the molten metal drop is not allowed to oxidize.

12. The method according to claim 11, further comprising forming the nanocarbide from an aqueous slurry directly onto the surface of the metallic particle.

13. The method according to claim 11, wherein the nanocarbide is tungsten carbide.

14. A thermally sprayed coating formed from a metallic powder coated with nanocarbides.

15. The thermally sprayed coating according to claim 14, wherein the nanocarbide is tungsten carbide.

16. The thermally sprayed coating according to claim 14, which is free of oxide layers.

17. The thermally sprayed coating according to claim 14, which is produced in a method for preventing the oxidation of metals in thermal spraying, comprising
attaching nanocarbides to the surface of metallic powder particles to be used in thermal spraying, followed by
spraying the coated metallic powder by thermal spraying into a metal coating on the surface of a body, whereby the nanocarbides provide a reduction reaction of the carbides on the surface of the metal powder particles during the molten state of the spraying, so that the surface of the molten metal drop is not allowed to oxidize.

18. A method for coating metallic powder particles to be used for a coating in thermal spraying, wherein said method comprises attaching nanocarbides to the surface of the metallic powder particles.

19. The method according to claim 18, further comprising forming the nanocarbide from an aqueous slurry directly onto the surface of the metallic particle.

20. The method according to claim 18, wherein the nanocarbide is tungsten carbide.
